(19) United States
(12) Patent Application Publication
(10) Pub. No.: US 2018/0142667 A1
(43) Pub. Date: May 24, 2018

(54) Buoyancy Driven Water Wheel and Energy Recovery System

(71) Applicant: Kholusi Musa Kayed Mallah, Amman (JO)

(72) Inventor: Kholusi Musa Kayed Mallah, Amman (JO)

(21) Appl. No.: 15/646,458

(22) Filed: Jul. 11, 2017

Related U.S. Application Data
(60) Provisional application No. 62/497,605, filed on Nov. 23, 2016.

(51) Int. Cl. F03B 17/02

(52) U.S. Cl. CPC F03B 17/02; F05B 2210/12; F05B 2240/97; F05B 2220/32; F05B 2220/706; F05B 2210/401

(57) ABSTRACT

A buoyancy driven water wheel has a circular frame partially disposed in a water tank, an air valve provided in the center of the circular frame in fluid communication with an air source, a plurality pipes, each pipe having a proximal end in fluid communication with the air valve, and a distal end on the circumference of the wheel frame one or more airbags provided at the distal end of and in fluid communication with each of the pipes, a gear shaft extending from and fixed to the center of the circular frame, and one or more supports to position the circular frame within the water tank, wherein the air valve directs air from an air source to the one or more airbags at an underwater inflation position, and wherein inflation of the airbags at the underwater inflation position rotates the circular frame.

### CROSS-REFERENCE TO RELATED APPLICATION(S)

The present application claims priority to U.S. Provisional Patent Application No. 62/497,605 filed on Nov. 23, 2016, entitled “Buoyancy Driven Water Wheel” the entire disclosure of which is incorporated by reference herein.

### BACKGROUND OF THE INVENTION

### 1. Field of Invention

The present invention relates to the field of renewable energy sources, and more specifically renewable energy generated from the mechanical energy of a rotating wheel.

### 2. Description of Related Art

The history of the water wheel can be dated the 4th century BCE. Water wheels utilize the energy of free-flowing or falling water to be converted into useful mechanical energy. The mechanical energy produced by the water wheel could be used in irrigation and as a power source. Water wheels were often used to power mills, which included a variety of tools to be powered by the mechanical energy obtained from the rotation of the water wheel.

In more recent times, the mechanical energy generated from a water wheel has been used to generate electricity when an axial connection is made from the wheel to a generator. The generated electricity can be connected to lights, machinery, stored in a battery, or used to power most devices requiring electricity. Water wheels generally operate at about 60 percent efficiency, and with only a flowing body of water required, water wheels may be considered a reliable source of renewable and clean energy. However, a river, stream, waterfall, tidal bore, or other form of a flowing body of water may not be readily available in most situations.

Based on the foregoing, there is a need in the art for a water wheel that can generate electrical energy in absence of a flowing body of water. Furthermore, what might be desired is a water wheel that can be driven by buoyant forces in a system which the power output is greater than the power input.

### SUMMARY OF THE INVENTION

In an embodiment, the present invention is an energy recovery system. The system allows for energy lost as byproduct compressed air to be partially recovered and converted into mechanical, and eventually, electrical energy. In an embodiment, the energy recovery system features a buoyancy driven water wheel.

The present invention provides a wheel with a series of air bags around the circumference that are selectively inflatable. The wheel is half-submerged within a tank of water, such that when the air bag is inflated under the water, the lift provides a rotational force to the wheel, creating rotation energy from compressed air from a compressed air source.

A buoyancy driven water wheel has a circular frame partially disposed in a water tank, an air valve provided in the center of the circular frame in fluid communication with an air source, a plurality pipes, each pipe having a proximal end in fluid communication with the air valve, and a distal end on the circumference of the wheel frame one or more airbags provided at the distal end of and in fluid communication with each of the pipes, a gear shaft extending from and fixed to the center of the circular frame, and one or more supports to position the circular frame within the water tank, wherein the air valve directs air from an air source to the one or more airbags at an underwater inflation position, and wherein the air valve directs air out of the airbag at a deflation point, and wherein inflation of the airbags at the underwater inflation position rotates the circular frame.

The water wheel may have air sourced from a byproduct of processes. A blower may be present to provide air pressure to the air valve. A gearbox may also be in connection with the gear shaft. There may also be an electric generator in connection with the gear shaft and/or gear box.

An energy recover system is disclosed having an air source, comprised of compressed air sourced from a byproduct of processes, a buoyancy driven water wheel having a circular frame partially disposed in a water tank, an air valve provided in the center of the circular frame in fluid communication with the air source, a plurality pipes, each pipe having a proximal end in fluid communication with the air valve, and a distal end on the circumference of the wheel frame, one or more airbags provided at the distal end of and in fluid communication with each of the pipes, a gear shaft extending from and fixed to the center of the circular frame, and one or more supports to position the circular frame within the water tank, a gearbox in mechanical communication with the gear shaft of the buoyancy driven water wheel, and a generator in mechanical communication with the gearbox, wherein the air source provides compressed air to the buoyancy driven water wheel, wherein the buoyancy driven water wheel rotates as the airbags are inflated underwater, wherein the gear shaft of the buoyancy driven water wheel turns the gearbox, and wherein the gearbox turns the generator to convert mechanical energy into electricity.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the buoyancy driven water wheel, according to an embodiment of the present invention;

FIG. 2 is a front elevational view of the buoyancy driven water wheel, according to an embodiment of the present invention;

FIG. 3 is a left elevational view of the buoyancy driven water wheel, according to an embodiment of the present invention, and

FIG. 4 is a perspective view of the pore inflation component of the buoyancy driven water wheel, according to an embodiment of the present invention.

### DETAILED DESCRIPTION OF PREFERRED EMBODIMENTS

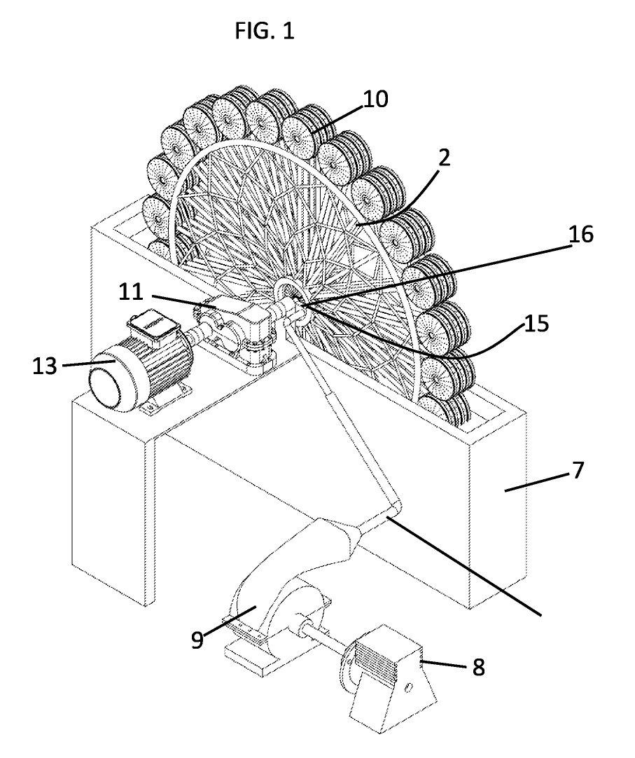

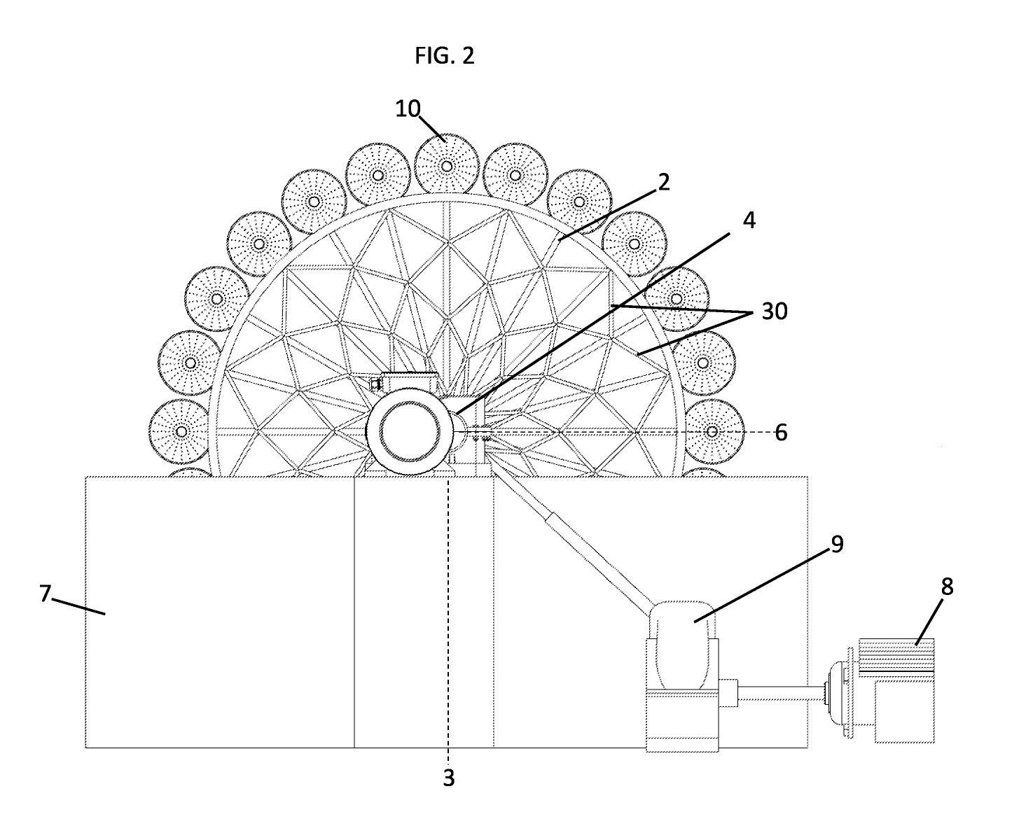

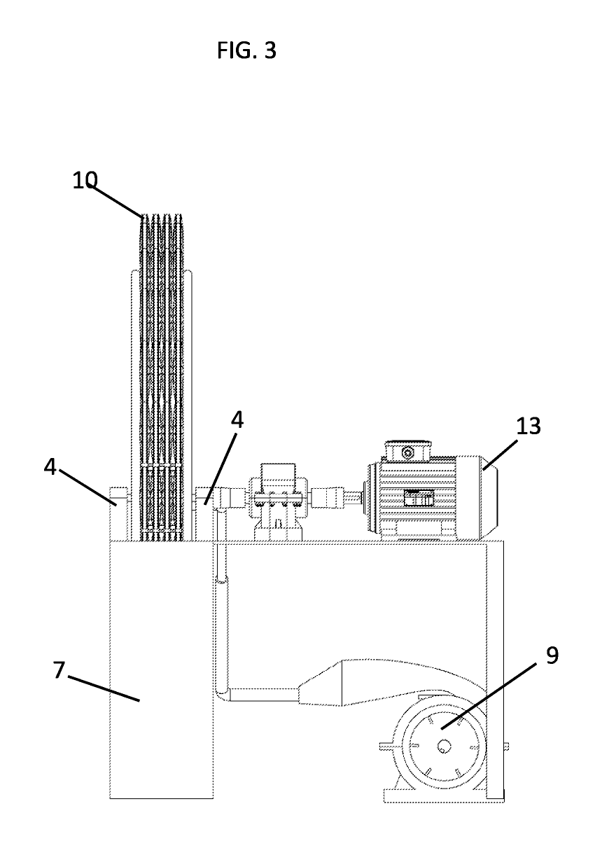

Preferred embodiments of the present invention and their advantages may be understood by referring to FIGS. 1-4, wherein like reference numerals refer to like elements.

With reference to FIG. 1, the present invention provides a wheel 1 with a series of air bags 10 around the circumference that are selectively inflatable. The wheel 1 is half-submerged within a tank 7 of water, such that when the air bag 10 is inflated under the water, the lift provides a rotational force to the wheel 1, creating rotation energy from compressed air from a compressed air source 9.

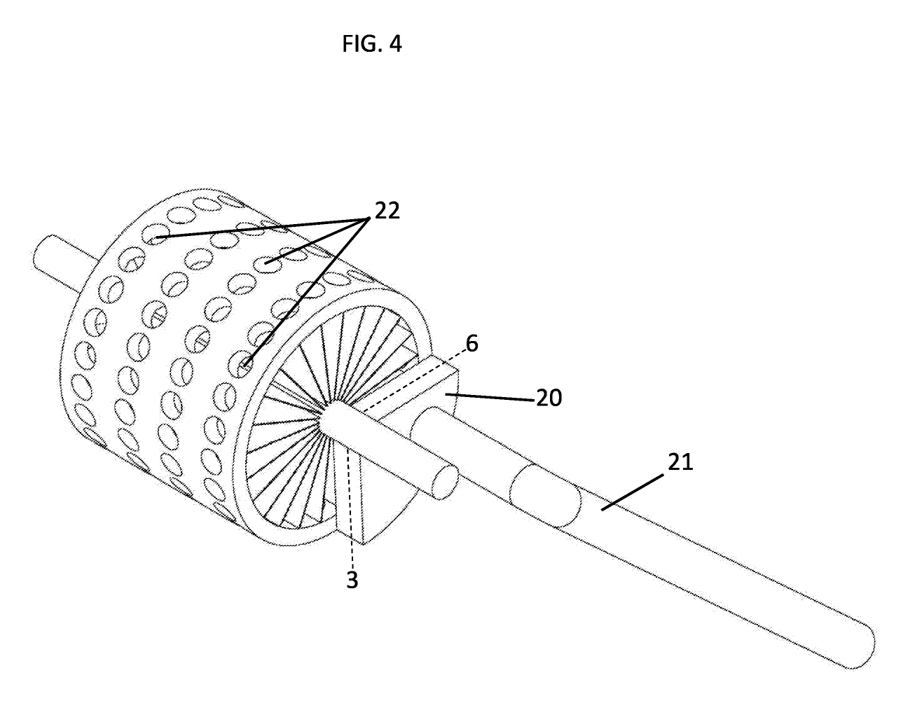

In reference to FIG. 1-3, according to an embodiment, the buoyancy driven water wheel 1 is shown. The wheel 1 is further comprised of a plurality of pipes 2 extending from the center 16 of the wheel. The center 16 of the wheel 1 is provided with a pressurized air valve 15 therein (shown in detail in FIG. 4). In fluid communication with the plurality of pipes 2. Each pipe 2 is provided with one or more airbags 10 at the circumference 18 of the wheel 1, selectively inflatable by the pipes 2 and air valve 15.

In an embodiment, the pressurized air valve 15 is provided in the center of the wheel. The air valve is configured such that when the pipes 2 reach an inflation position 3, preferably just forward of about 6 o'clock on the wheel in an embodiment, wherein the air valve 15 opens to push air to flow through the pipes 2 and into the airbags 10, to inflate the airbags.

The wheel 1 is positioned partially submerged within a tank 7 containing water, and the wheel 1 is further provided with one or more supports 4 to hold the wheel in a rotating position suspended above the bottom of a water tank 7.

Upon inflation, the airbags 10 will produce a buoyance force, pushing the air bag out of the water in which it is submerged and causing the wheel to rotate. When a pipe reaches the deflation position 6, the air is removed from the air bag to be fully deflated after exiting the tank. The configuration is provided such that a repeated and subsequent inflation of a series of airbags 10 at the inflation position 3 provides lift and hence a continuous rotation of the wheel 1. In the preferred embodiment, at any given moment a quarter or a sixth of the airbags are inflated to create a maximum moment of rotation from the buoyancy force of the airbags 10 inflated in the tank 7. In an embodiment, the bags deflate once they exit the water exhausting air through the air valve at the center of the wheel, in preparation for the next inflation.

According to an embodiment, the buoyancy driven water wheel 1 is further provided with a pressurized air source such as a blower 8 powered by a motor 9 to be in fluid communication with the air valve 15 at the center of the wheel. In an embodiment, the air source 8 and blower 9 will provide all the pressurized air to inflate the airbags 10 through an air inlet 21.

In a preferred embodiment, the center 1 of the wheel is axially connected to a gearbox 11 via a gear shaft 14. The gearbox 11 is provided to rotate an axle 12 at a rotational velocity which is accepted by a generator 13, wherein the generator produces electrical power from the rotational energy.

In an embodiment, the buoyancy driven water wheel 1 is further provided with a plurality of support bars 30 which provide further support to the structure of the wheel.

In the embodiment, the configuration of the buoyancy driven water wheel allows for the mechanical energy from the rotation of the wheel 1, caused by the buoyant force of the inflated bags 10, is translated to the generator to be converted into electrical energy. In an embodiment, the buoyancy driven water wheel 1 may be used as an energy recovery device used to recover energy from processes that produce pressurized air as a by-product.

In an embodiment, the length of the pipes 2, size of the airbags 10, and ratios of the gear 11 may be varied depending on power output requirements and pressurization of the air source.

In reference to FIG. 4, a detailed view of the pore inflation system is shown. In an embodiment, the air pump 9 provides compressed air to the airtight compartment 20 of the pore system through an air inlet bore 21. The pore inflation system is arranged such that the pores 22 enter an airtight compartment 20 in communication with the compressed air pipes 2, at the inflation position 3 as the system rotates. The compressed air then enters through pores 22 and is forced into the pipes 2 to inflate the airbags at the end of the pipes. When the pores 22 rotate out of the airtight compartment 20 (at deflation position 6) the air can escape from the pores 22 and the airbags at the end of the pipes 2 are allowed to deflate. In the embodiment shown, one pore is provided for each pipe 2, each set row consists of five pipes 2, and each pipe 2 is provided with one airbag 10 at its circumferential end. It can be appreciated by one skilled in the art, that the number of pipes 2 per row, the number of pores per pipe, and the number of airbags 10 per pipe can may be varied appropriately to achieve desired results.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A buoyancy driven water wheel having:
a. a circular frame partially disposed in a water tank;
b. an air valve provided in the center of the circular frame in fluid communication with an air source;
c. a plurality pipes, each pipe having:
i. a proximal end in fluid communication with the air valve; and
ii. a distal end on the circumference of the wheel frame
d. one or more airbags provided at the distal end of and in fluid communication with each of the pipes;
e. a gear shaft extending from and fixed to the center of the circular frame; and
f. one or more supports to position the circular frame within the water tank;
wherein the air valve directs air from an air source to the one or more airbags at an underwater inflation position, and wherein the air valve directs air out of the airbag at a deflation point, and wherein inflation of the airbags at the underwater inflation position rotates the circular frame.

2. The buoyancy driven water wheel of claim 1, wherein the air is sourced from a byproduct of processes.

3. The buoyancy driven water wheel of claim 1, further comprising a blower to increase air pressure to the air valve.

4. The buoyancy driven water wheel of claim 1, further comprising a gearbox in connection with the gear shaft.

5. The buoyancy driven water wheel of claim 1, further comprising an electric generator in connection with the gear shaft.

6. The buoyancy driven water wheel of claim 4, further comprising a generator in connection with the gear box.

7. An energy recover system having:
a. an air source, comprised of compressed air sourced from a byproduct of processes;
b. a buoyancy driven water wheel having:
i. a circular frame partially disposed in a water tank;
ii. an air valve provided in the center of the circular frame in fluid communication with the air source;
iii. a plurality pipes, each pipe having:
1. a proximal end in fluid communication with the air valve; and
2. a distal end on the circumference of the wheel frame
iv. one or more airbags provided at the distal end of and in fluid communication with each of the pipes;
v. a gear shaft extending from and fixed to the center of the circular frame; and
vi. one or more supports to position the circular frame within the water tank;
c. a gearbox in mechanical communication with the gear shaft of the buoyancy driven water wheel; and
d. a generator in mechanical communication with the gearbox;
wherein the air source provides compressed air to the buoyancy driven water wheel, wherein the buoyancy driven water wheel rotates as the airbags are inflated underwater, wherein the gear shaft of the buoyancy driven water wheel turns the gearbox, and wherein the gearbox turns the generator to convert mechanical energy into electricity.
